(19) United States
(12) Patent Application Publication
(10) Pub. No.: US 2008/0159189 A1
(43) Pub. Date: Jul. 3, 2008

(54) Wireless Card and External Antenna Connecting Device of the Same

(75) Inventor: Gary Hsu, Linkou Township (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: BANDRICH INC., Sindian City (TW)

(21) Appl. No.: 11/617,107

(22) Filed: Dec. 28, 2006

(51) Int. Cl. H04B 7/00

(52) U.S. Cl. 370/310

(57) ABSTRACT

A wireless card includes a body, a circuit device, an adjustable antenna and an external antenna connecting device. The body includes an insertion portion and an outer portion connected to an end of the insertion portion. The circuit device is mounted inside the body. The external antenna connecting device is mounted on the outer portion and includes a connecting base, an external antenna connector and a cover. The connecting base has a chamber in which the external antenna connector is mounted. The cover is mounted on the connecting base to cover the chamber when the external antenna connector is not used to connect an external antenna. The connecting base is made of light-transmitting material, and the circuit device comprises at least one illuminating devices corresponding to the connecting base through which light emitted by illuminating devices enters the connecting base to enhance indications of connection status.

### BACKGROUND

1. Field of the Invention

The present invention relates to a wireless mobile communications device. More particularly, the present invention relates to a wireless card for mobile communications.

2. Description of Related Art

Next generation mobile communications technologies and terminal equipment are continuously developed to satisfy the increasing demands of mobility. Those mobile communication technologies and terminal equipment seek not only to improve communication speed and quality, but also provide communication terminals that are convenient to use, look good and are portable to meet consumer demand.

Typically, portable information technology (IT) products, such as laptops require wireless cards to establish a wireless communication environment. The wireless cards have various designs and features based on the specifications of different wireless communication protocols. Especially, developments and the growth of mobile communications technologies are faster for implementing convenient wireless communication.

Recently, the majority of mobile communication technologies focus on accelerating the data transmission speeds and improving data transmission quality. Several major mobile communication protocols, such as globe system for mobile communications (GSM) of second generation (2G) standards, general packet radio service (GPRS) of 2.5G standards, wideband code division multiple access (WCDMA) of 3G standards and even recent high speed downlink packet access (HSDPA) of 3.5G standards have been developed and are continuously improved to substantially accelerate the transmission speed.

Generally, the wireless card uses antennas to receive and transmit wireless signals. Antenna size and location are major design challenges that influence the performance of signal reception and transmission. Further, lo different countries adopt different mobile communication technologies and different band frequencies. User environment of the portable electronic device is changed following the mobility of the user. Thus, using a single antenna cannot satisfy the dual requirements of good signal reception and transmission.

Consequently, recently developed wireless cards provide several built-in or adjustable antennas. However, end users cannot change or expand the dimensions and locations of the built-in or adjustable antennas. Users can only obtain better reception and transmission quality by adjusting orientations of the adjustable antenna. However, the convention wireless cards are not expendable and compatible for connecting to external antennas.

In addition, the external antenna connecting device mounted on the wireless card should be accommodated for the entire appearance of the wireless card. If the external antenna connecting device is directly exposed on the wireless card, the entire wireless card is unsightly and not attractive to consumers, and may further influence the engineering design of the adjustable antenna.

The conventional wireless card also uses only one or more indicating light, such as LEDs to indicate various connection status and operation status. Since the LEDs only provide small illuminating areas, the indicating effect is limited. The users may not quickly and conveniently see the indicating lights to know the current connection status.

Therefore, there is a need to provide an improved wireless card to mitigate or obviate the aforementioned problems.

### SUMMARY

An object of the present invention is to provide a wireless card with built-in antennas and with the capability of connecting an external antenna to increase its applications and expansion, without changing the entire appearance of the wireless card.

Another object of the present invention is to provide an external antenna connecting device for a wireless card, and the external antenna connecting device is easy and convenient to use, and is nice to look at.

A wireless card in accordance with the present invention includes a body, a circuit device, an adjustable antenna and an external antenna connecting device. The body includes an insertion portion and an outer portion connected to an end of the insertion portion. The circuit device is mounted inside the body.

The external antenna connecting device is mounted on the outer portion and includes a connecting base, an external antenna connector and a cover. The connecting base has a chamber in which the external antenna connector is mounted. The cover is mounted on the connecting base to cover the chamber when the external antenna connector is not used to connect an external antenna.

Preferably, the connecting base is made of light-transmitting material, and the circuit device comprises at least one illuminating device corresponding to the connecting base through which light emitted by the illuminating devices enters the connecting base to enhance indications of the connection status.

Consequently, the wireless card provides a capability of connecting an external antenna. When there is no need to use an external antenna, covering the chamber by the cover hides the external antenna connector. The cover can be designed with the entire wireless card to make the entire appearance of the wireless card aesthetic, clean and nice to look at. Thus, applications and expansion of the wireless card have been enhanced, and the external antenna connecting device is convenient and easy to use.

In addition, light beams produced by the illuminating device enter the connecting base and are refracted by the connecting base to present a large illuminating area to indicate current connection and equipment status of the wireless card. Users can quickly and conveniently obtain information of the current connection and operation status through the large illuminating area. Further, the connecting base is an integral block so that an amount number of the illuminating device is a design selection, which provides design flexibility. Further, the illuminating device may use LEDs with various colors to indicate respectively various connection statuses.

### BRIEF DESCRIPTION OF THE DRAWINGS

These and other features, aspects, and advantages of the present invention will become better understood with regard to the following description, appended claims, and accompanying drawings where:

FIG. 1 is a perspective view of a wireless card of an embodiment in accordance with the present invention;

FIG. 2 is an exploded perspective view of the wireless card in FIG. 1;

FIG. 3 is an exploded perspective view of an external antenna connecting device of the wireless card in FIG. 1;

FIG. 4 is a bottom perspective view of a connecting base of the external antenna connecting device in FIG. 3;

FIG. 5 is an operational perspective view of the wireless card in FIG. 1; and

FIG. 6 is an enlarged perspective view of a circuit device of the wireless card in FIG. 1.

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

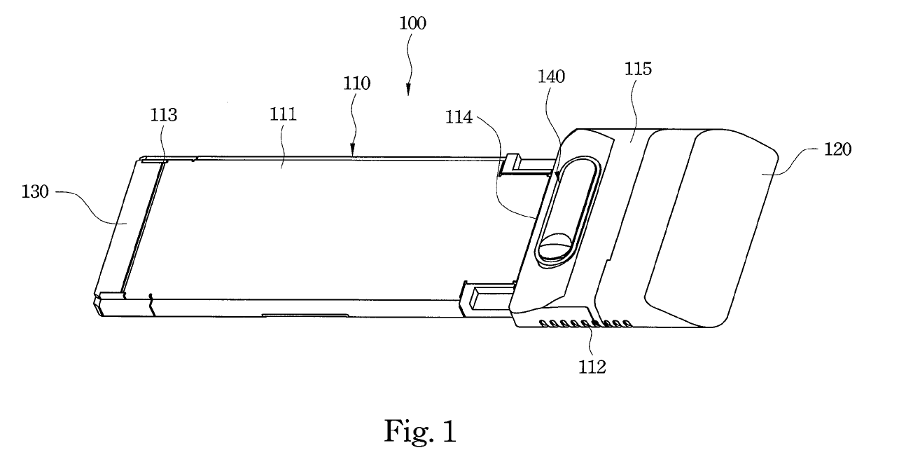

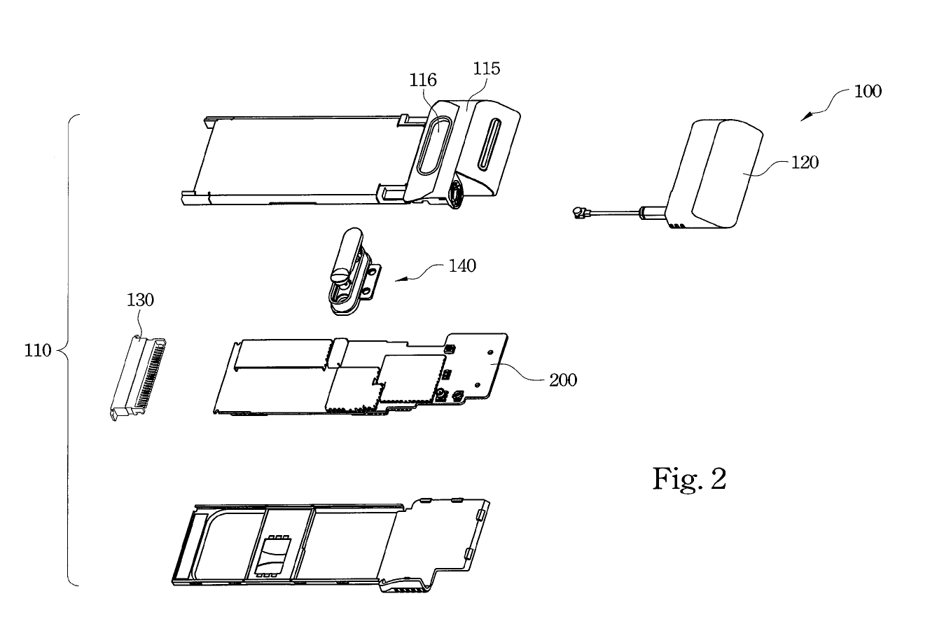

Refer to FIG. 1 and FIG. 2. A wireless card 100 in accordance with the present invention comprises a body 110, an adjustable antenna 120, a transmission interface 130, an external antenna connecting device 140 and a circuit device 200. The body 110 comprises an insertion portion 111 and an outer portion 112. The circuit device 200 is mounted inside the body 110.

The insertion portion 111 has a first end 113 and a second end 114 opposite to the first end 113. The transmission interface 130 is connected to the first end 113 and is electrically connected to the circuit device 200. When the wireless card 100 is used to establish a wireless communications environment, inserting the insertion portion 111 into a slot of a portable electronic device (such as a laptop) until the transmission interface 130 electrically connects to the portable electronic device. The transmission interface 130 may be an express card transmission interface, a universal serial bus (USB) transmission interface, a personal computer memory card international association (PCMCIA) transmission interface, or a CompactFlash (CF) card transmission interface.

The outer portion 112 is mounted on the second end 114 of the insertion portion 111 and has a top 115 and a mounting hole 116 defined in the top 115. Further, the outer portion 112 holds a portion of the circuit device 200 inside. The adjustable antenna 120 is adjustably mounted on the outer portion 112 and is electrically connected to the circuit device 200. The adjustable antenna 120 may be adjusted by pivoting it relative to the outer portion 112 to change its orientation.

Further, one or more than one built-in antennas may be mounted on the portion of the circuit device 200 inside to the outer portion 112. The built-in antennas are incorporated with the adjustable antenna 120 to provide the ability to achieve multi-band and multi-path radio reception and transmission for the wireless card 100.

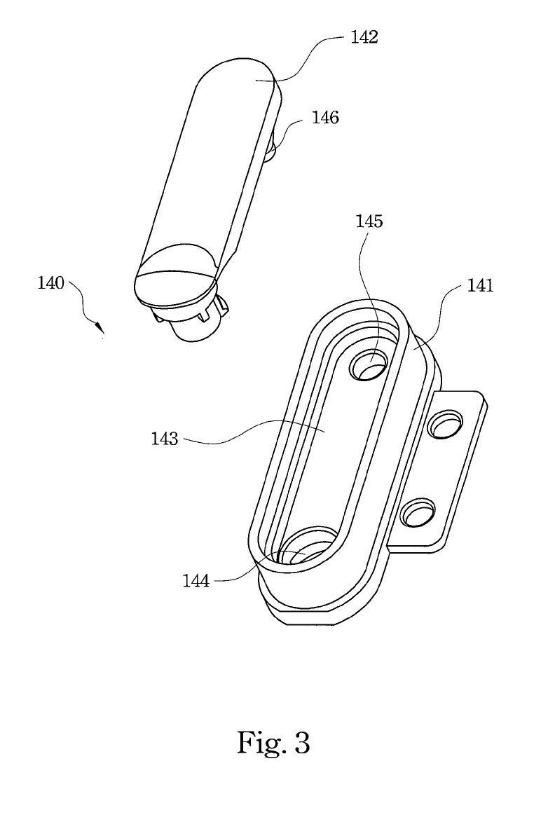

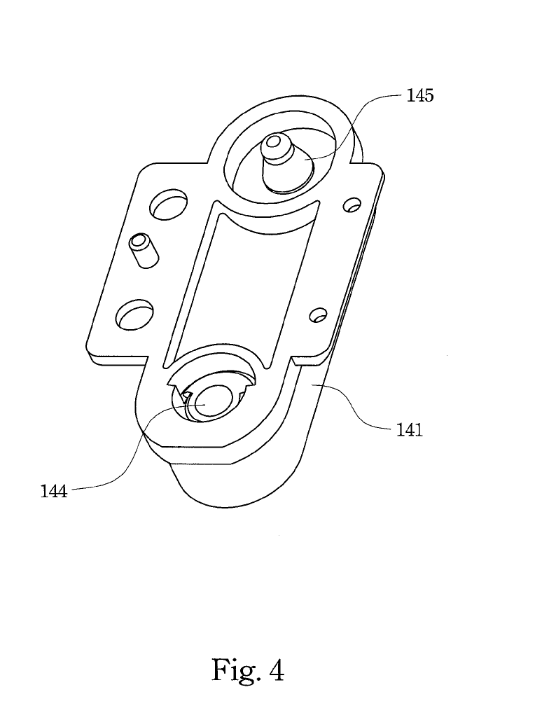

Refer is made to FIG. 3 and FIG. 4 The external antenna connecting device 140 is mounted on the outer portion 112 so as to provide the wireless card 100 the ability to connect an external antenna. However, the mutual influences between those antennas including the built-in antenna, the adjustable antenna 120 and the connected external antenna may occur. In the preferred embodiment, the external antenna connecting device 140 is mounted on the top 115 of the outer portion 112. The top 115 means the upper side of the outer portion 112 when the wireless card 100 is inserted into the portal electronic device (such as a laptop), and the portal electronic device is placed in a normal position for usage (such as the laptop is put on a desk).

The external antenna connecting device 140 comprises a connecting base 141, an external antenna connector 144 and a cover 142. The connecting base 141 is mounted in the mounting hole 116 and has a chamber 143 and a cover seat 145. The chamber 143 has a bottom in which the external antenna connector 144 and the cover seat 145 are mounted. Further, the external antenna connector 144 is electrically connected to the circuit device 200 and is adapted to connect an external antenna for antenna expansion for the wireless card 100.

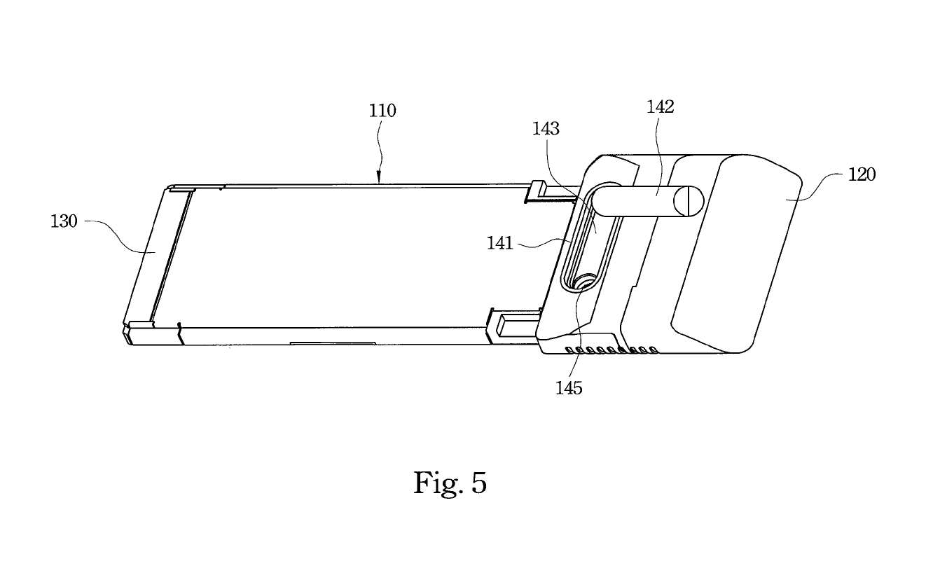

Refer to FIG. 1 and FIG. 5. The cover 142 is mounted on the connecting base 141 to cover the chamber 143 when the external antenna connector 144 is not used to connect an external antenna. The cover 142 has a protrusion 146. The protrusion 146 is pivotally mounted in the cover seat 145 so that the cover 142 can be pivoted relative to the connecting base 141 to open or close the chamber 143. Consequently, when the cover 142 is opened, an external antenna can be connected to the external antenna connector 144 through which it is electrically connected to the circuit device 200. Further, the cover 142 may be made of soft or flexible materials so that the chamber 143 can be opened by either bending or pivoting the cover 142. Thus, the external antenna connecting device 140 is convenient and easy to use.

When there is no need to connect an external antenna, covering the chamber 143 with the cover 142 conceals the external antenna connector 144 to make the entire appearance of the wireless card 100 aesthetic, clean and nice to look at.

Since the mutual influences between those antennas including the built-in antenna, the adjustable antenna 120 and the connected external antenna may occur, in the preferred embodiment, the external antenna connector 144 is circular with a central line, the adjustable antenna 120 has a pivotal axis positioned at a distance of about 6 millimeters (mm) from the central line.

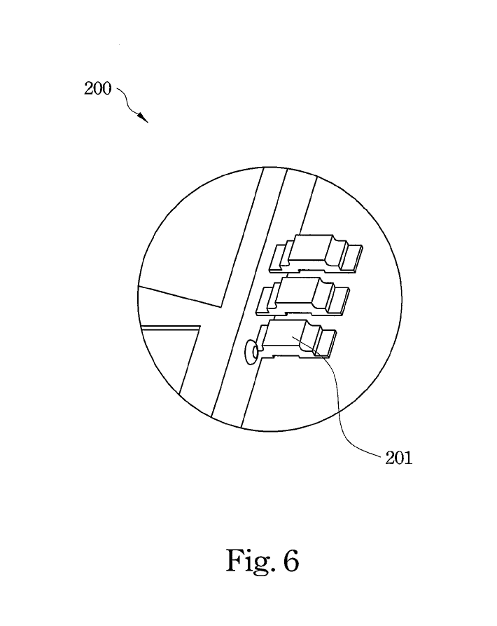

Reference is made to FIG. 6. The circuit device 200 comprises one or more than one illuminating device 201. The illuminating devices 201 are positioned at a position corresponding to the connecting base 14l. The connecting base 141 is made of light-transmitting material and is partially exposed on the top 115 of the outer portion 112. The illuminating devices 201 may be light emitting diodes (LEDs) and emit different color lights. Thus, the light beams produced by the illuminating device 201 enter the connecting base 141, are refracted by the connecting base 141, and go out of the outer portion 112 at the top 115. Thus, the connecting base 141 provides a large illuminating area for indicating current connection and operation status of the wireless card 100. Users can quickly and conveniently obtain information of the current connection and operation status through the large illuminating area provided by the connecting base 141. Further, the connecting base 141 is an integral block so that a number of the illuminating devices 201 are a design selection, which provides design flexibility. In addition, the illuminating device 201 may use LEDs with various colors.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A wireless card comprising
a body comprising an insertion portion and an outer portion, the insertion portion having a first end and a second end opposite to the first end, and the outer portion connected to the second end;
a circuit device mounted in the body;
a transmission interface connected to the first end of the body and electrically connected to the circuit device;
an adjustable antenna adjustably mounted on the outer portion; and
an external antenna connecting device mounted on the outer portion and comprising
a connecting base having a chamber;
an external antenna connector mounted inside the chamber of the connecting base; and
a cover mounted on the connecting base to cover the chamber;
whereby the external antenna connector is adapted to connect to an external antenna when the cover is opened.

2. The wireless card as claimed in claim 1, wherein the outer portion of the body has a top and a mounting hole defined in the top, and the connecting base is mounted in the mounting hole.

3. The wireless card as claimed in claim 1, wherein the transmission interface is an express card transmission interface, a universal serial bus (USB) transmission interface, a personal computer memory card international association (PCMCIA) transmission interface, or a CompactFlash (CF) card transmission interface.

4. The wireless card as claimed in claim 1, wherein the adjustable antenna is pivotally mounted on the outer portion of the body.

5. The wireless card as claimed in claim 4, wherein the external antenna connector is circular with a central line, the adjustable antenna has a pivotal axis positioned at a distance of about 6 millimeters from the central line.

6. The wireless card as claimed in claim 1, wherein
the connecting base further comprises a cover seat mounted in the chamber, the chamber has a bottom, and the cover seat and the external antenna connector are mounted on the bottom of the chamber; and
the cover has a protrusion pivotally mounted in the cover seat.

7. The wireless card as claimed in claim 1, wherein the cover is made of soft material.

8. The wireless card as claimed in claim 1, wherein the cover is made of flexible material.

9. The wireless card as claimed in claim 1, wherein
the connecting base is made of light-transmitting material; and
the circuit device comprises at least one illuminating device corresponding to the connecting base.

10. The wireless card as claimed in claim 9, wherein each of the at least one illuminating device is a light emitting diode (LED).

11. An external antenna connecting device for being mounted on a wireless card, and the external antenna connecting device comprising
a connecting base having a chamber;
an external antenna connector mounted inside the chamber of the connecting base; and
a cover mounted on the connecting base to cover the chamber;
whereby the external antenna connector is adapted to connect to an external antenna for the wireless card when the cover is opened.

12. The external antenna connecting device as claimed in claim 11, wherein the wireless card has a top and a mounting hole defined in the top, and the connecting base is mounted in the mounting hole.

13. The external antenna connecting device as claimed in claim 11, wherein
the connecting base further comprises a cover seat mounted in the chamber, the chamber has a bottom, and the cover seat and the external antenna connector are mounted on the bottom of the chamber; and
the cover has a protrusion pivotally mounted in the cover seat.

14. The external antenna connecting device as claimed in claim 11, wherein the cover is made of soft material.

15. The external antenna connecting device as claimed in claim 11, wherein the cover is made of flexible material.

16. The external antenna connecting device as claimed in claim 11, wherein the connecting base is made of light-transmitting material.
